(19) United States
(12) Patent Application Publication
(10) Pub. No.: US 2013/0052927 A1
(43) Pub. Date: Feb. 28, 2013

(54) Laboratory Fume Hood With A Projection Apparatus

(71) Applicants: Olaf Broemsen, Moerfelden (DE); Edmund Frickel, Gruendau (DE); Christoph Noll, Gruendau (DE); Oliver Rupp, Giessen (DE)

(72) Inventors: Olaf Broemsen, Moerfelden (DE); Edmund Frickel, Gruendau (DE); Christoph Noll, Gruendau (DE); Oliver Rupp, Giessen (DE)

(73) Assignee: THERMO ELECTRON LED GMBH, Langenselbold (DE)

(21) Appl. No.: 13/590,303

(22) Filed: Aug. 21, 2012

(30) Foreign Application Priority Data
Aug. 29, 2011 (DE) 10 2011 111 949.7

(51) Int. Cl. B08B 15/02; B01D 50/00

(52) U.S. Cl. 454/56

(57) ABSTRACT

The present invention relates to a laboratory fume hood, especially a safety cabinet, comprising a working space which is enclosed by a housing and which is closable by an especially movable front window. It comprises a projection apparatus in order to project an image into the working space.

### CROSS-REFERENCE TO RELATED APPLICATIONS

The present application claims priority under 35 U.S.C. §119 of German Patent Application No. 10 2011 111 949.7, filed Aug. 29, 2011, the disclosure of which is hereby incorporated herein by reference in its entirety.

### FIELD OF THE INVENTION

The present invention relates to a laboratory fume hood and especially a safety cabinet with a working space which is enclosed by a housing, which can be closed off with a front window and in which samples can be processed in a protected manner.

### BACKGROUND OF THE INVENTION

Laboratory fume hoods and safety cabinets differ from one another depending on the protection that they offer. Safety cabinets are currently subdivided into three classes depending on the protection offered to the user and the processed samples. Regulations in this respect can be found in the standards DIN EN 12469:2000 and DIN 12980:2005. The present invention relates to all such devices, i.e., simple laboratory fume hoods, laminar-flow cabinets and safety cabinets of classes I to III. Laboratory fume hoods will be referred to below in a generalized manner for all these types of apparatuses.

Maintaining a specific air flow is required for ensuring the necessary protection in all cases of laboratory fume hoods. In the case of safety cabinets of class II, for example, a major part of the air flow circulating in the working space will be guided in a vertical laminar falling flow from the top to the bottom. This falling flow can be disturbed considerably by installations in the working space. For this reason, installations in the interior working space such as screens attached to the rear wall of the working space require a separate homologation test so that the required safety is ensured. These screens, which are used for displaying device information, for example, further lead to pressure losses in the return air channel. Moreover, undesirable dirt particles can reach the interior working space and the cleaning of the interior working space will be rendered more difficult by the presence of the screen.

### SUMMARY OF THE INVENTION

It is therefore the object of the present invention to provide a laboratory fume hood and especially a safety cabinet which allows displaying information in the interior working space without leading to the aforementioned disadvantages, i.e., especially avoiding the impairment to the air circulation in the working space, and enabling easier cleaning.

In its broadest aspect, the present invention therefore relates to a laboratory fume hood and especially a safety cabinet with a working space enclosed by a housing, which working space can be sealed with an especially movable front window. In this respect, the device therefore does not differ from previously known devices. In contrast to the latter, however, it comprises a projection apparatus in order to project an image into the working space. The use of the projection apparatus and the images projected into the working space allow omitting an image display apparatus in the interior of the working space. The disadvantages as described above will therefore consequently be avoided. There is no display apparatus such as a monitor in the laboratory fume hood in accordance with the present invention which might impair the air flow in the working space or render cleaning more difficult. The projection apparatus is preferably also arranged outside of the working space and projects images into the working space. The arrangement of the projection apparatus in the working space is possible, even though this is less preferable. Since it does not need to be visible for the user in contrast to a display apparatus, it will and can be preferably arranged in a region which does not disturb the air flow in the working space or disturbs such air flow only to a very low extent.

As was already described above, the term of “laboratory fume hood” relates within the terms of the present invention to any kind of a laboratory fume hood, which therefore also includes any kind of safety cabinet such as those of classes Ito III and laminar-flow and product safety cabinets such as vaccine banks. All these devices can easily be used within the scope of the present invention because the application of a projection apparatus outside of the working space is easily possible in all cases.

The projection apparatus that can be used in accordance with the present invention may concern any kind of projection apparatus which is capable of projecting an image from the outside into the working space. Examples of suitable projection apparatuses are conventional slide projectors or video beamers. It is also possible to use a projector with which a display of an electronic device such as a computer or mobile phone will be projected. Projectors can be mentioned as examples for this type of a projection apparatus which are capable of projecting a partially transparent LCD display or a reflective micro-display such as an LCOS (liquid crystal on silicon). Similarly, suitable projectors are scanning projectors such as laser projection apparatuses.

Such projection apparatuses are frequently used in combination with an optical projection system. It comprises at least one reflecting mirror and/or at least one lens. The at least one reflecting mirror is used for deflecting the light beam emitted by the projection apparatus into a different direction and therefore allows the arrangement of the projection apparatus to the side of the projection area and therefore in an area in which the projection apparatus will disturb the user of the laboratory fume hood to the lowest possible extent. It is understood that it is also possible to arrange the projection apparatus in such a way that the light beam will be emitted directly and without any deflection onto the projection area. The at least one lens of the optical projection system is used for setting the focus and size of the projected image or for smoothing the image. In addition to the aforementioned elements, the optical projection system can also comprise further components for improving the quality of the projection. Electronic image correction processes (keystone correction or the like) and processes for adjusting the brightness depending on the ambient luminosity, etc., can also be used.

The projection can principally occur at any suitable location of the working space. Such regions will obviously be preferred which can be seen especially well by the user. The projection of the image onto the rear wall of the working space which is opposite of the front window is therefore preferable. A projection to one of the side walls of the working space or even the worktop is also possible, with the regions of the worktop being preferred in the latter case which are disposed outside of the main working and depositing areas.

It is alternatively possible to optically delimit certain regions on the working area in order to predetermine certain procedures for the use in this way and to simplify observing said procedures. The use of suitable diaphragms allows producing projections which differ from one another in respect of position and optionally also in respect of color, for example. At the same time, the job instructions can be projected either in the working area itself or preferably in an adjacent area together with the various working areas. This allows guiding the user step by step through the individual steps of a job instruction, with every step preferably being associated with a special working area, thereby increasing procedural safety.

For the purpose of increasing information density, images from several data sources can be projected simultaneously (so-called picture-in-picture projection or picture-and-picture projection). The information content can be increased even further if several projection apparatuses are used instead of one projection apparatus. The projection apparatuses are preferably in all cases arranged outside of the working space and project images into the working space. The images projected by different projection apparatuses can be displayed in the known manner in an overlaid fashion or adjacent to one another.

It is principally possible to project the images directly onto the areas provided in the working space. If the projection quality should prove to be insufficient, it is also possible to modify the projection area. A surface modification is preferred for the improvement of the projection quality which can be achieved, for example, by a coat of paint or the application of a film. Such films are known from projection screens, for example. The advantage of such a measure is that there is an only very low increase in material which does not lead to any impairment in the air flow within the working space. It is alternatively also possible to introduce the projection area as a separate component into the working space and to fix or install the same at a suitable location in the working space. Fixing appropriately occurs in such a way that the projection area can easily be removed from the working space again so that cleaning the interior working space will not be obstructed. Furthermore, the projection area will appropriately be positioned in such a way that it disturbs neither the user during his or her work nor the air flow within the working space.

In a further variant, the projection area can consist of a glass pane on which an image will be projected as in a head-up display of an aircraft or a motor vehicle. The glass pane can either concern a glass area already provided in the laboratory fume hood such as one of the glass side walls or also the front window of the laboratory fume hood. They shall also be considered to belong to the interior of the working space within the terms of the present invention because images projected onto the same in the working space can be recognized by the user. It is alternatively possible to integrate a glass pane into the rear wall of the working space, preferably flush with the rear wall. The projection onto this glass pane then occurs from the outside to the surface of the glass pane facing away from the interior of the working space, but it can still be seen through the glass pane. Instead of integration in the rear wall, the glass pane can also be inserted into any other wall delimiting the working space or the worktop. In this case too, integration preferably occurs flush with the areas delimiting the working space so as to prevent obstructing the air flow and to facilitate cleaning.

The at least one projection apparatus which is used in connection with the laboratory fume hood in accordance with the present invention can either be mounted in a fixed manner outside of the working space on the laboratory fume hood, or a fixing device is preferably provided on the laboratory fume hood to which the projection apparatus can be fixed in a releasable manner. The fixing device appropriately also comprises the required plug-in connections in this case in order to connect the projection apparatus with the required power and data cables. The fixing device appropriately also ensures that the projection apparatus will be positioned in the correct orientation relative to the working space.

The entire range of information can principally be displayed with the projection apparatus which is interesting to the user of the laboratory fume hood. Which specific information is displayed at any given time can either be fixedly predetermined by the control of the laboratory fume hood, and/or the users can decide themselves which information is to be displayed. It can be useful, for example, to permanently display relevant information for the operation of the laboratory fume hood or to show warning notices when the operation of the device is disturbed. It may also be useful at the same time to provide notices to the user concerning appropriate procedures to be performed in respect of the disturbance. It is further preferable to provide the user with the possibility to seek information in the operating manual of the device and to have such information displayed with the projection apparatus in the working space.

The retrievable information can be stored, for example, either in a memory of the device itself which is provided for this purpose, or in an external storage medium which is connected via a data connection with the projection apparatus of the laboratory fume hood. The data line can concern a wire-bound or wireless connection, for example. The wireless data transmission such as a wireless LAN network, for example, is principally known and therefore need not be described in closer detail. Suitable external storage media are a computer, which also includes a portable PC such as a notebook, tablet PC, etc., a mobile phone, a USB stick or a memory card. A suitable data connection such as a USB interface can be provided on the projection apparatus for reading the latter two storage media. The selection of the data to be displayed by the projection apparatus occurs in the former two cases appropriately via the external device, i.e., the computer or the mobile phone. In the latter two cases the selection is preferably performed by a control apparatus of the laboratory fume hood.

The control apparatus especially preferably concerns a remote control which the user can bring along to the working space. Such a remote control is known from EP 1 354 643 A2 of the applicant. It is suitable for selection by the user irrespective of the type of information to be displayed and its origin. As an alternative to the remote control, the selection can also be made via a control unit which is fixedly connected with the laboratory fume hood. In addition to the selection of the type of information, it can appropriately also be provided to allow the user to choose the type of display, i.e., the type of illustration (color, black/white), position of the projection, layout, etc.

A further possibility to enable the user to operate the laboratory fume hood and the connected devices is projecting a virtual control panel with the projection apparatus onto the projection area, e.g., in form of a keyboard, for example. The user will use the projected virtual control panel like a real one, in that the user will press with his or her fingers onto the projected keys. The determination of the finger movements of the user will occur in the known manner, e.g., in such a way that laser or infrared radiation will be emitted to the region of the projection area and the change in the reflected light will be determined on the basis of the disturbance caused by the fingers of the user in specific areas of the keyboard. The use of the projected control panel is varied because the type of the control panel, the keyboard layout, etc., can be changed, for example, depending on the menu level of the control of the laboratory fume hood or the stage of a job sequence which is currently performed by the user. Depending on the actions performed by the user it is therefore possible to project an adapted control panel into the working space. It is therefore possible to provide the control panel for the user with a very simple and clear configuration. The use of such a projected control panel offers the advantage that the user can operate the safety cabinet without allowing his or her hands to leave the working space and without having to place a real control panel into the working space which might be contaminated there.

General information such as the time, the monitored process parameters and job sequences or work instructions belongs to the further information that can be displayed with the projection apparatus. The user can preferably display the individual steps of a production or analytic process either in its entirety or successively depending on the progress in the work. The work can further be facilitated in such a way that the user will be displayed data from analytical devices and/or measuring apparatuses. This can especially concern data of such devices which are arranged in the working space such as scales, microscopes or the like. It is also possible to generally transmit and display data from devices which are disposed outside of the laboratory fume hood. Data transmission can again occur in a wire-bound or wireless manner. This allows the user of the laboratory fume hood to check and observe work processes that are processed in parallel.

“Observing” shall also be understood in the literal sense of the meaning. It is also possible to transmit image material recorded by a camera and transmitted to the projection apparatus into the working space. The camera can be situated both in the working space and also outside of the same, on the laboratory fume hood or remote from the same. In a first variant, the camera is used, for example, to film sequences which occur within the working space of the laboratory fume hood. It is possible, for example, that the user will commence the work performed by the same within the working space in order to have it projected into the working space in an enlarged manner so that it is easier to recognize for the user. The image material obtained in this manner can further be stored and archived in order to be used as documentation of the job procedures. The camera can be arranged within the working space or preferably outside of the working space, e.g., filming through a glass pane that seals the working space.

In a second variant, the camera transmits images from the ambient environment of the laboratory fume hood. The user of the laboratory fume hood is thereby able to observe the ambient environment without having to interrupt the ongoing work.

In a third variant, the camera transmits images from regions which the user of the laboratory fume hood would not be able to see without leaving his or her place of work. This can concern images from adjacent rooms for example where tests are performed which can now be monitored by the user of the laboratory fume hood in this manner. As already mentioned, measured values of such tests can additionally be projected into the working space of the laboratory fume hood. The use of several cameras is obviously also possible.

### BRIEF DESCRIPTION OF THE DRAWINGS

The present invention will be explained below in closer detail by reference to drawings, wherein the drawings in which the same reference numerals designate the same parts schematically show the following:

FIG. 1 shows a cross-sectional view through a laboratory fume hood in accordance with the present invention on the basis of an example of a class II safety cabinet; and

FIG. 2 shows a top view of a further embodiment of a safety cabinet in accordance with the present invention.

### DETAILED DESCRIPTION

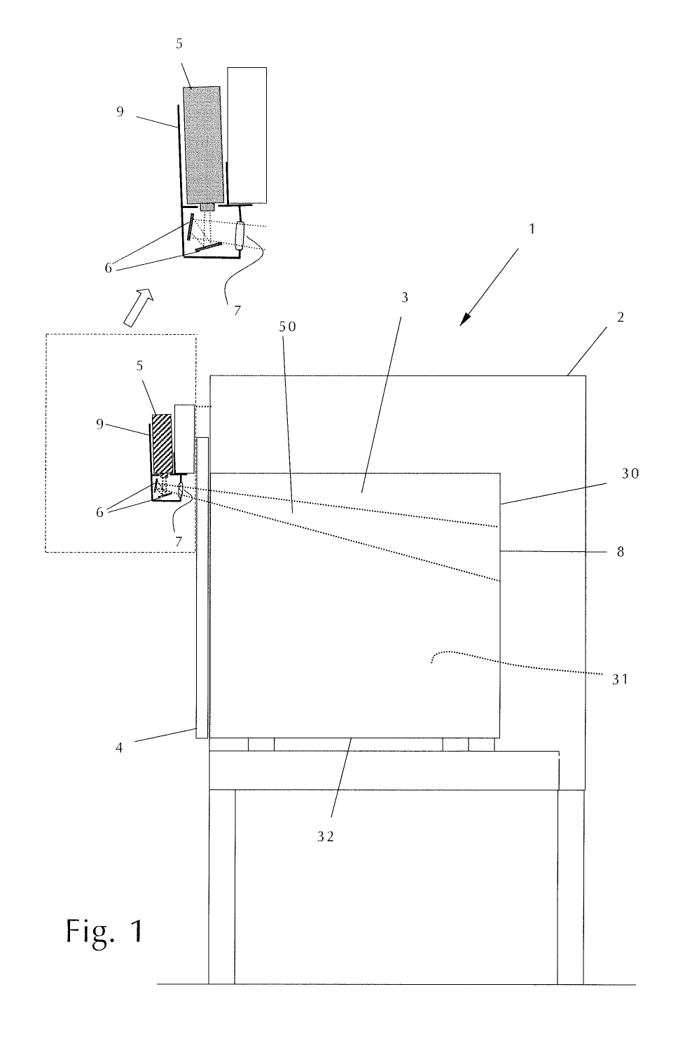

FIG. 1 shows a cross-sectional view of a class II safety cabinet which in respect of its principal configuration corresponds to a conventional safety cabinet. The safety cabinet 1 comprises a working space 3 for safe processing of samples, which working space is enclosed by a housing 2. The working space 3 can be sealed on the front side by a front window 4 which is upwardly and downwardly displaceable. The safety cabinet in accordance with the present invention differs from a conventional safety cabinet in such a way that it comprises a projection apparatus 5 with which images can be projected from the outside into the working space. In the illustrated case, the projection apparatus 5 is fixed by means of a fixing device 9 to the housing 2 of the safety cabinet 1, which in this case occurs on the front side of the housing, mostly above the work opening which allows access to the working space 3. The projection apparatus 5 concerns a video beamer for example which receives data from an external device such as a computer and/or the control unit of the safety cabinet 1 via a wire-bound or wireless data connection (not shown). The data converted into images will be projected by the projector onto a projection area 8 which is disposed in this case in the upper region of the rear wall 30 which delimits the working space 3. The light beam 50 which is emitted by the projector 5 will be deflected by two reflecting mirrors 6 in the direction towards the rear wall 30 and emitted via a lens 7 which is provided for improving the image quality on the projection area 8 (cf. the enlarged section of the dashed area). The image quality can further be improved in such a way that the rear wall 30 is surface-treated, e.g., coated, in the region of the projection area 8.

It is similarly possible in an alternative embodiment which is not shown here to arrange the projection area 8 for displaying image data transmitted by the projector in a region of the worktop 32 or one of the side walls 31 which delimit the working space 3. It is also possible to use several projection apparatuses 5 which project different image material simultaneously or successively.

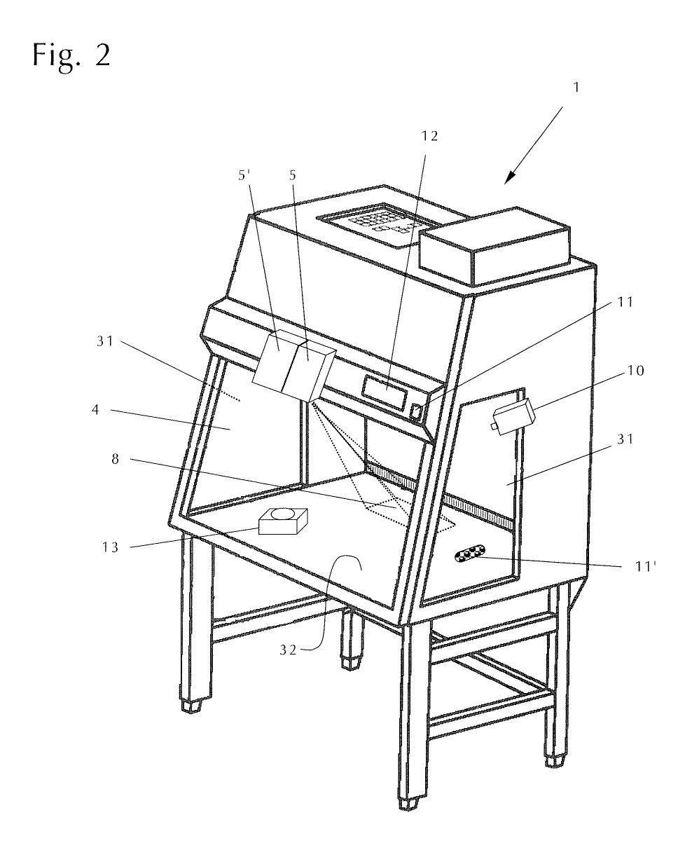

Such a possibility with several projection apparatuses is shown in FIG. 2. The safety cabinet 1 also concerns such a safety cabinet in this case whose principal configuration corresponds to that of the state of the art. Instead of the one projection apparatus in FIG. 1, two projection apparatuses 5 and 5′ are arranged on the front side of the housing 2 above the work opening to the working space 3. These projection apparatuses 5 and 5′ are able to project image material into the interior of the working space 3 either simultaneously or successively. The drawing shows a case in which a projection area 8 is disposed in the rear region of the worktop 32 of the safety cabinet 1. The fixing device 9 and the optical projection system which consists of reflecting mirrors and lenses have been omitted for clarity of the illustration, but can principally be arranged as shown in FIG. 1.

The simultaneous use of the projection apparatuses 5 and 5′ allows the parallel display of different information from different data sources on the projection area 8. It is obviously also possible to provide separate projection areas in different regions of the working space 3 for each of the projection apparatuses. The selection of the illustrated information can occur as desired. Reference is made again by way of example to the display of operating instructions, job instructions, device parameters of the safety cabinet 1, analytical data or measuring parameters, general information such as time, etc. In the illustrated case, scales 13 are disposed in the working space 3 for example, which scales are connected via a wireless or wire-bound data connection with one of the projection apparatuses, which in this case is the projection apparatus 5. As a result, the weighing results of the scales 13 can be displayed in form of an image via the projection apparatus 5 onto the projection area 8.

A camera 10 is additionally arranged outside of the safety cabinet 1, which camera is able to film through a glass side wall 31 into the working space 3. This allows the user to observe and have his work displayed in a preferably enlarged manner via one of the projection apparatuses (which in this case is the projection apparatus 5′ for example which is connected via a wireless or wired-bound data connection with the camera 10) onto the projection area 8.

Two control apparatuses 11 and 11′ are provided for operating the safety cabinet 1 which can be used by the user selectively. The control apparatuses 11 concerns a rocker switch as has been described in DE 102 17 903 C1. The control and selection menu is shown in display 12. In addition, a remote control 11′ is provided as is known for example from EP 1 354 643 A2. The user menus of the control apparatuses 11 and 11′ and the control of the safety cabinet 1 are set up in such a way that the user can choose via the control apparatuses 11 and 11′ the information to be displayed by the projection apparatuses 5 and 5′. It can additionally be provided that the user can choose via the control apparatuses 11 and 11′ the form in which the image material is to be displayed by the projection apparatuses 5 and 5′.

A further possibility for operation is provided to the user by the possibility of projecting a control panel in form of a keyboard for example onto the projection area 8 by means of one of the projection apparatuses 5 or 5′. The determination of the finger movements of the user on the keyboard occurs in the known manner, e.g., in such a way that the laser or infrared radiation is emitted to the region of the projection area and the change in the reflected light will be determined by the disturbance caused by the fingers of the user in specific areas of the keyboard. The use of such a projected control panel offers the advantage that the user can operate the safety cabinet without allowing his or her hands to leave the working space 3 and without having to place a real control panel into the working space 3 which might be contaminated there.

While the present invention has been illustrated by description of various embodiments and while those embodiments have been described in considerable detail, it is not the intention of Applicants to restrict or in any way limit the scope of the appended claims to such details. Additional advantages and modifications will readily appear to those skilled in the art. The present invention in its broader aspects is therefore not limited to the specific details and illustrative examples shown and described. Accordingly, departures may be made from such details without departing from the spirit or scope of Applicants' invention.

What is claimed is:

1. A laboratory fume hood, comprising:
a working space which is enclosed by a housing and which is closable by a movable front window, wherein at least one projection apparatus is comprised in order to project an image into the working space.

2. The laboratory fume hood according to claim 1, wherein the at least one projection apparatus is arranged outside of the working space.

3. The laboratory fume hood according to claim 1, wherein the at least one projection apparatus is a slide projector, a video beamer or a projector for projecting a display of a device.

4. The laboratory fume hood according to claim 1, wherein the at least one projection apparatus comprises an optical projection system which has at least one reflecting mirror and/or at least one lens.

5. The laboratory fume hood according to claim 1, wherein the at least one projection apparatus is arranged in such a way that the image is projected onto a rear wall disposed opposite of the front window, a side wall or a worktop of the working space.

6. The laboratory fume hood according to claim 1, wherein a projection area used for projection is surface-modified for improving the quality of the projection.

7. The laboratory fume hood according to claim 1, wherein a pair of projection apparatuses are provided for the projection of images into the working space.

8. The laboratory fume hood according to claim 1, wherein the at least one projection apparatus is detachably fastened to a fixing device of the laboratory fume hood.

9. The laboratory fume hood according to claim 1, wherein at least one camera is provided which records image material, from the working space and/or the ambient environment of the laboratory fume hood, and transmits said material to the at least one projection apparatus.

10. The laboratory fume hood according to claim 1, wherein the images transmitted by the at least one projection apparatus project at least one of the following pieces of information:
an operating instruction;
a job instruction;
data on an operating state of the laboratory fume hood;
data from analytical devices and/or measuring apparatuses, which are arranged in the working space;
image material transmitted by a camera;
data stored on an external storage medium of a computer, mobile phone, USB stick or a memory card; and
a control panel.

11. The laboratory fume hood according to claim 10, wherein a control apparatus is provided with which a user can choose the projection at will for at least a part of the information.

12. The laboratory fume hood according to claim 1, wherein the laboratory fume hood comprises a safety cabinet.

13. The laboratory fume hood according to claim 3, wherein the device comprises a computer or a mobile phone.

14. The laboratory fume hood according to claim 3, wherein the display of the device comprises a partially transparent LCD display, a reflective micro-display or a liquid crystal on silicon display.

15. The laboratory fume hood according to claim 1, wherein the control panel comprises a keyboard.
